(19) United States
(12) Patent Application Publication
(10) Pub. No.: US 2003/0149804 A1
(43) Pub. Date: Aug. 7, 2003

(54) Interface circuit and semiconductor device

(76) Inventor: Katsumi Tsukada, Ina-shi (JP)

Correspondence Address: HARNESS, DICKEY & PIERCE, P.L.C., P.O. BOX 828, BLOOMFIELD HILLS, MI, 48303, US

(21) Appl. No.: 10/346,725

(22) Filed: Jan. 17, 2003

(30) Foreign Application Priority Data
Jan. 22, 2002 (JP) 2002-012441

(51) Int. Cl. G06F 3/00

(52) U.S. Cl. 710/1

(57) ABSTRACT

An interface circuit is provided that shortens the time for which the first CPU cannot use the bus, and minimizes the load on the second CPU. The circuit is equipped with an SRAM that is capable of storing data for one page of the data stored in an SDRAM, and a control section that, upon receiving from a host CPU a page number specifying one of the pages in the SDRAM, transfers to the SRAM data in a page corresponding to the page number; upon receiving from the host CPU a read access request to the data in the SRAM, reads the data requested by the host CPU from the SRAM and transmits the data to the host CPU; and upon receiving from the host CPU a write access request to the data in the SRAM, receives the data transferred by the host CPU and writes the data in the SRAM.

### TECHNICAL FIELD

The present invention relates to an interface circuit that performs data transfer between a first memory connected to a first CPU through a bus and a second CPU. Furthermore, the present invention relates to a semiconductor device using such an interface circuit.

### BACKGROUND

Conventionally, information processing devices that include two CPUs, such as, PDAs (personal data assistants) and mobile telephone devices have been used. FIG. 3 shows one example of such a conventional PDA. As indicated in FIG. 3, a PDA 41 is equipped with an input section 42, a RAM 43, a ROM 44, a host CPU 45, an LCD controller 50, an LCD driver 61 and an LCD panel 62.

The input section 42 may be a touch panel or the like for inputting data or the like by the user.

The input section 42, RAM 43, ROM 44 and host CPU 45 are mutually connected to one another through a first bus 46. The host CPU 45, depending on data or the like inputted through the input section 42, performs overall control of the PDA 41 by executing an OS (operating system) program, an application program and the like stored in the ROM 44 while using the RAM 43 as a work area.

The LCD controller 50 includes an interface circuit 51, a CPU 52, a SDRAM 53 and a flash memory 54. The interface circuit 51, CPU 52, SDRAM 53 and flash memory 54 are mutually connected to one another through a second bus 55.

The flash memory 54 stores a program that is executed by the CPU 52.

The SDRAM 53 is divided into a plurality of pages each having a specified size, wherein the program stored in the flash memory 54 is transferred to one of the pages upon booting up. Also, the other pages of the SDRAM 53 store image data for displaying images or the like on a display screen of the LCD panel 62.

The interface circuit 51 performs a signal transfer between the host CPU 45 and the SDRAM 53. More specifically, the interface circuit 51, when the host CPU 45 reads data from the SDRAM 53, receives an address and wait signal outputted form the host CPU 45 and outputs the same onto the bus 55, and receives data outputted from the SDRAM 53 and outputs the same to the host CPU 45. Also, the interface circuit 51, when the host CPU 45 writes data in the SDRAM 53, receives an address and wait signal outputted from the host CPU 45 and outputs the same onto the bus 55, and receives data outputted from the host CPU 45 and outputs the same to the SDRAM 53.

The CPU 52 executes the program stored in one of the pages in the SDRAM 53, thereby performing predetermined processes on the image data stored in the other pages in the SDRAM 53.

The LCD driver 61 reads the image data from the SDRAM 53 through the bus 55, and drives the LCD panel 62 based on the image data read out to have the LCD panel 62 display images on its display screen.

In the PDA 41 indicated in FIG. 3, while the host CPU 45 is accessing the SDRAM 53, the bus 55 is occupied by the data transfer between the CPU 45 and the SDRAM 53, and the CPU 52 cannot use the bus 55, which is problematic. Also, because the host CPU 45 needs to arbitrate for the bus 55 as a bus arbiter, the load to the host CPU 45 is heavy, which is problematic.

In view of the problems discussed above, a first object of the present invention is to provide an interface circuit that performs data transfer between a first memory that is connected to a first CPU through a bus and stores data divided in a plurality of pages and a second CPU, which can shorten the time the first CPU cannot use the bus, and lowers the load on the second CPU. Further, a second object of the present invention is to provide a semiconductor device that includes such an interface circuit.

### SUMMARY

To solve the problems discussed above, an interface circuit in accordance with the present invention performs data transfer between a first memory that is connected to a first CPU through a bus and stores data divided in a plurality of pages and a second CPU. The interface circuit comprises: a second memory that is capable of storing data for one page of the data stored in the first memory; and a control section that, upon receiving from the second CPU page information specifying one of the plurality of pages in the first memory, copies data in the page specified by the page information onto the second memory; upon receiving from the second CPU a read access request to data in the second memory, reads the data requested by the second CPU from the second memory and transmits the data to the second CPU; and upon receiving from the second CPU a write access request to data in the second memory, receives the data transferred by the second CPU and writes the data in the second memory.

Here, the second memory may be capable of accessing at a higher speed than the first memory.

Also, the control section, upon receiving an instruction from the second CPU to transfer data stored in the second memory to the first memory, may transfer the data stored in the second memory to a page specified by the page information. Also, the control section, upon receiving from the second CPU second page information to specify one of the plurality of pages in the first memory, may transfer data stored in the second memory to a page specified by the page information, and then copy data in the page specified by the second page information onto the second memory. Furthermore, the control section may transfer only data that is rewritten in the second memory to a page specified by the page information.

Also, the control section, upon receiving from the second CPU a write access request to data in the second memory, may receive data transferred by the second CPU and write the data in the second memory, and may write the data in the first memory.

The control section may perform a burst transfer between the first memory and the second memory.

Further, a semiconductor device in accordance with the present invention is equipped with: a first CPU; a first memory that is connected to the first CPU through a bus, and stores data divided in a plurality of pages; and an interface circuit of the present invention that transfers data between the first memory and an external second CPU.

By the above-described structure in accordance with the present invention, the time the first CPU cannot use the bus is shortened, and the load on the second CPU can be reduced.

### BRIEF DESCRIPTION OF THE DRAWINGS

FIG. 1 is a diagram of a structure of a PDA using an interface circuit in accordance with an embodiment of the present invention.

FIG. 2 is a drawing illustrating a memory map of an DSRAM of FIG. 1.

FIG. 3 is a diagram of a structure of a conventional PDA.

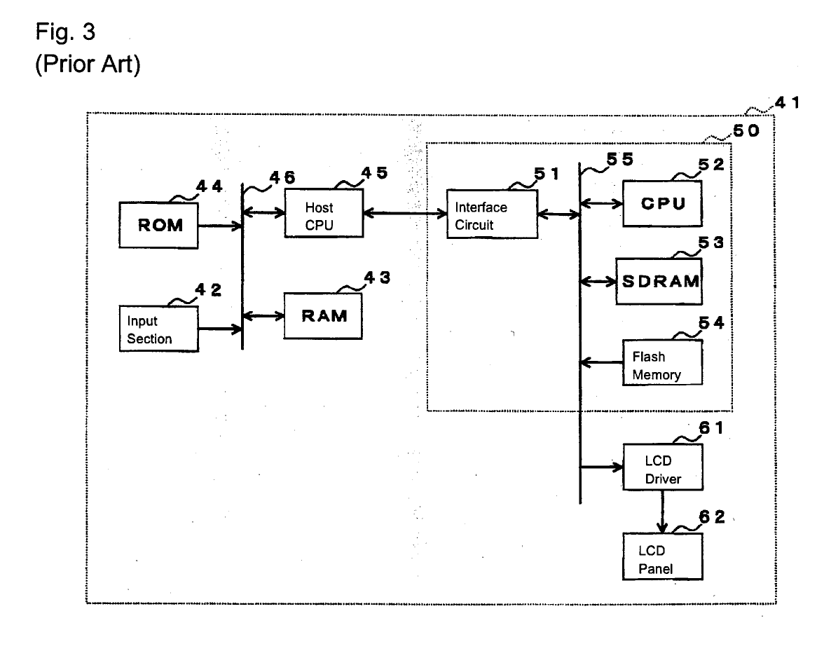

### DETAILED DESCRIPTION

An embodiment of the present invention is described below with reference to the accompanying drawings.

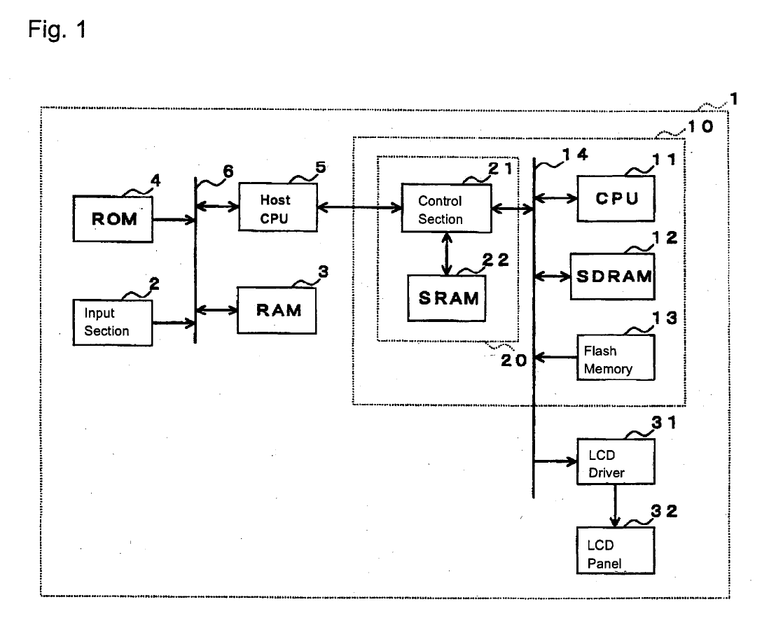

FIG. 1 shows a structure of a PDA that uses an interface circuit in accordance with an embodiment of the present invention.

As indicated in FIG. 1, a PDA 1 is equipped with an input section 2, a RAM 3, a ROM 4, a host CPU 5, an LCD controller 10, an LCD driver 31 and an LCD panel 32.

The input section 2 may be a touch panel or the like for inputting data or the like by the user.

The input section 2, RAM 3, ROM 4 and host CPU 5 are mutually connected to one another through a first bus 6. The host CPU 5, depending on data or the like inputted through the input section 2, performs overall control of the PDA 1 by executing an OS (operating system) program, an application program and the like stored in the ROM 4 while using the RAM 3 as a work area.

The LCD controller 10 includes an interface circuit 20, a CPU 11, a synchronous DRAM (SDRAM) 12 and a flash memory 13. The interface circuit 20, CPU 11, SDRAM 12 and flash memory 13 are mutually connected to one another through a second bus 14.

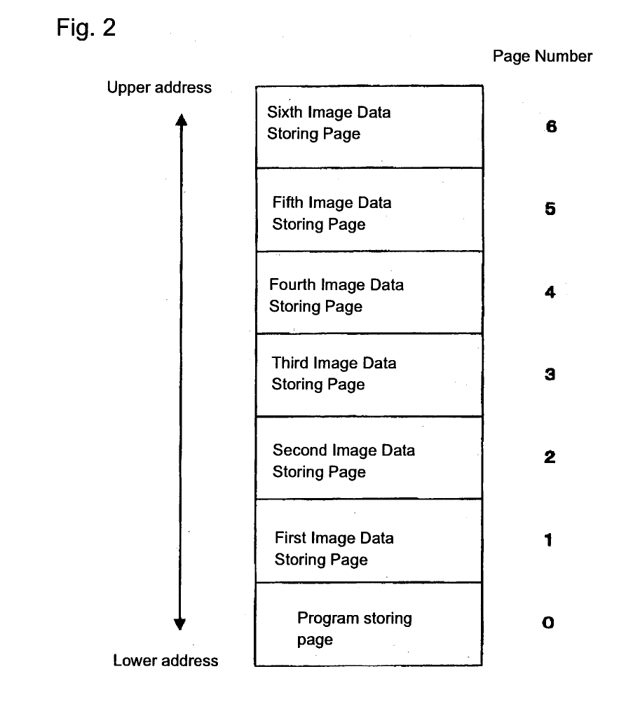

FIG. 2 shows a memory map of the SDRAM 12. As shown in FIG. 2, the SDRAM 12 is divided, from lower to upper addresses, into a program storing page that stores a program to be executed by the CPU 11, and seven pages, i.e., first through sixth image data storing pages that store image data for displaying images on a display screen of the LCD panel 32; and page numbers 0-6 are assigned to these pages, respectively. It is noted that the first through sixth image data storing pages have the same size.

Referring back to FIG. 1, the flash memory 13 stores a program that is executed by the CPU 11, and the program is transferred to the program storing page in the SDRAM 12 upon booting up the PDA 1.

The interface circuit 20 in accordance with the embodiment of the present invention includes a control section 21, and an SRAM 22 that is capable of storing data for one page among the first through sixth image data storing pages, and performs data transfer between the host CPU 5 and the SDRAM 12. It is noted that the SRAM 22 is capable of accessing at higher speeds than the SDRAM12.

Operations of the interface circuit 20 are described below in detail.

The host CPU 5, when it is necessary to access image data stored in the SDRAM 12, transfers a page number of a page that stores the image data to the control section 21 in the interface circuit 20.

The control section 21, upon receiving the first page number from the host CPU 5, generates an address signal and wait signal according to the first page number and outputs the same to the bus 14, and burst-transfers image data stored in a page corresponding to the first page number to the SRAM 22. Upon completing the burst-transfer of the image data from the SDRAM 12 to the SRAM 22, the control section 21 notifies the CPU 5 of the completion. Alternatively, the control section 21 may be equipped with a status register such that, upon completing the burst-transfer, a specified bit within the status register may be set to thereby notify the host CPU 5 of the completion of burst-transfer.

The host CPU 5, when reading data stored in the SRAM 22, transmits to the control section 21 an address at which the desired data is stored. The control section 21 reads from the SRAM 22 data corresponding to the address received from the host CPU 5, and transmits the same to the host CPU 5.

Also, the host CPU 5, when renewing data stored in the SRAM 22, transmits an address and renewal data to the control section 21. The control section 21 writes the data received from the host CPU 5 according to the address received from the host CPU 5.

In this manner, the host CPU 5 can access image data stored in a page corresponding to the first page number.

Also, the control section 21, upon receiving a second page number from the host CPU 5, transfers data stored in the SRAM 22 to a page corresponding to the first page number. After completing the transfer of the data renewed to the page corresponding to the first page number, the control section 21 transfers to the SRAM 22 data stored in a page corresponding to the second page number.

Alternatively, the control section 21 may be equipped with a status register such that, when the host CPU 5 sets a specified bit within the status register, data stored in the SRAM 22 may be transferred to a page corresponding to the first page number. Also, the control section 21 may transfer only data stored in the SRAM 22 which has been renewed by the host CPU 5 to a page corresponding to the first page number.

Also, when the host CPU 5 transfers to the control section 21 data to renew the data stored in the SRAM 22, the control section 21 may write in the SRAM 22 the data received from the host CPU 5, and also write in the SDRAM 12.

The CPU 5 executes the program stored in the program storing page in the SDRAM 12, thereby performing predetermined processes on the image data stored in the first through sixth image data storing pages in the SDRAM 12.

The LCD driver 31 reads the image data from the SDRAM 12 through the bus 14, and drives the LCD panel 32 based on the image data read out to have the LCD panel 32 display images on its display screen.

In this manner, the interface circuit 20, upon receiving from the host CPU 5 a page number, transfers to the SRAM 22 data in a page corresponding to the page number; upon receiving from the host CPU 5 a read access request to data in the SRAM 22, reads the data requested by the host CPU 5 from the SRAM 22 and transmits the data to the host CPU 5; and upon receiving from the host CPU 5 a write access request to data in the SRAM 22, receives the data transferred by the host CPU 5 and writes the data in the SRAM 22. Accordingly, the bus 14 is not occupied by the data transfer between the host CPU 5 and the SDRAM 12, and the time the CPU 11 cannot use the bus 14 can be shortened. Also, the host CPU 5 does not need to perform arbitration for the bus 14 as a bus arbiter, and therefore the load on the host CPU 5 can be made smaller. Further, by using the SRAM 22 that is faster than the SDRAM 12, the time for the host CPU 5 to read or write data can be shortened, such that the performance of the host CPU 5 can be improved.

As described above, the present invention, upon receiving from the second CPU page information specifying one of the plurality of pages, copies data in the page specified by the page information onto the second memory; upon receiving from the second CPU a read access request to data in the second memory, reads the data requested by the second CPU from the second memory and transmits the data to the second CPU; and upon receiving from the second CPU a write access request to data in the second memory, receives the data transferred by the second CPU and writes the data in the second memory. As a result, the time the first CPU cannot use the bus is shortened. Also, the load on the second CPU can be reduced because the second CPU does not need to perform an arbitration for the bus as a bus arbiter.

The entire disclosure of Japanese Patent Application No. 2002-012441 filed Jan. 22, 2002 is incorporated by reference herein.

What is claimed is:

1. An interface circuit that performs data transfer between a first memory that is connected to a first CPU through a bus and stores data divided in a plurality of pages and a second CPU, the interface circuit comprising:
a second memory adapted to store data for at least one page of the data stored in the first memory; and
a control section that:
upon receiving from the second CPU page information specifying one of the plurality of pages in the first memory, copies data in the page specified by the page information onto the second memory;
upon receiving from the second CPU a read access request to data in the second memory, reads the data requested by the second CPU from the second memory and transmits the data to the second CPU; and
upon receiving from the second CPU a write access request to data in the second memory, receives the data transferred by the second CPU and writes the data in the second memory.

2. The interface circuit according to claim 1, wherein the second memory is adapted to access at a higher speed than the first memory.

3. The interface circuit according to claim 1, wherein, the control section, upon receiving an instruction from the second CPU to transfer data stored in the second memory to the first memory, transfers the data stored in the second memory to a page specified by the page information.

4. The interface circuit according to claim 3, wherein the control section only transfers data that is rewritten in the second memory to a page specified by the page information.

5. The interface circuit according to claim 1, wherein the control section, upon receiving from the second CPU second page information to specify one of the plurality of pages in the first memory, transfers data stored in the second memory to a page specified by the page information, and then copies data in the page specified by the second page information onto the second memory.

6. The interface circuit according to claim 4, wherein the control section only transfers data that is rewritten in the second memory to a page specified by the page information.

7. The interface circuit according to claim 1, wherein the control section, upon receiving from the second CPU a write access request to data in the second memory, receives data transferred by the second CPU and writes the data in the second memory, and writes the data in the first memory.

8. The interface circuit according to claim 1, wherein the control section performs a burst transfer between the first memory and the second memory.

9. A semiconductor device comprising:
a first CPU;
a first memory that is connected to the first CPU through a bus, and stores data divided in a plurality of pages; and
an interface circuit according to claim 1 that transfers data between the first memory and an external second CPU.

10. A method of performing data transfer between a first memory that is connected to a first CPU through a bus and stores data divided in a plurality of pages and a second CPU with an interface circuit, method comprising:
in a second memory:
storing data for at least one page of the data stored in the first memory in a second memory; and
in a control section:
coping data in the page specified by the page information onto the second memory upon receiving page information specifying one of the plurality of pages in the first memory from the second CPU;
reading the data requested by the second CPU from the second memory and transmitting the data to the second CPU upon receiving a read access request to data in the second memory from the second CPU; and
receiving the data transferred by the second CPU and writing the data in the second memory upon receiving a write access request to data in the second memory from the second CPU.

11. The method according to claim 10, further comprising accessing with the second memory at a higher speed than the first memory.

12. The method according to claim 10, further comprising:
in the control section:
transferring the data stored in the second memory to a page specified by the page information upon receiving an instruction to transfer data stored in the second memory to the first memory from the second CPU.

13. The method according to claim 12, wherein the control section only transfers data that is rewritten in the second memory to a page specified by the page information.

14. The method according to claim 10, further comprising:
in the control section:
transferring data stored in the second memory to a page specified by the page information, and then copying data in the page specified by the second page information onto the second memory upon receiving second page information to specify one of the plurality of pages in the first memory from the second CPU.

15. The method according to claim 14, wherein the control section only transfers data that is rewritten in the second memory to a page specified by the page information.

16. The method according to claim 10, further comprising:
in the control section:
receiving data transferred by the second CPU and writing the data in the first and second memories upon receiving a write access request to data in the second memory from the second CPU.

17. The method according to claim 10, wherein the control section performs a burst transfer between the first memory and the second memory.
